(19) United States
(12) Patent Application Publication
(10) Pub. No.: US 2017/0185010 A1
(43) Pub. Date: Jun. 29, 2017

(54) IMAGE FORMING APPARATUS

(71) Applicant: CANON KABUSHIKI KAISHA, Tokyo (JP)

(72) Inventor: Isao Komatsu, Kashiwa-shi (JP)

(21) Appl. No.: 15/384,516

(22) Filed: Dec. 20, 2016

(30) Foreign Application Priority Data
Dec. 24, 2015 (JP) 2015-252520
Sep. 28, 2016 (JP) 2016-189954

(51) Int. Cl. G03G 15/20; G03G 15/00

(52) U.S. Cl. CPC G03G 15/2007

(57) ABSTRACT

An image forming apparatus includes an accommodating portion configured to accommodate a recording material; a first heating portion configured to heat the recording material accommodated in the accommodating portion; a recording material feeding portion configured to feed the recording material from the accommodating portion; an image forming portion configured to form an image, on a surface of the recording material fed by the recording material feeding portion, with a liquid developer containing toner and an ultraviolet curable agent; a second heating portion configured to heat the image, formed on the surface of the recording material, by irradiating the surface of the recording material with infrared radiation; and an ultraviolet irradiating portion configured to irradiate the surface of the recording material, with ultraviolet radiation, already irradiated with the infrared radiation by the second heating portion.

### FIELD OF THE INVENTION AND RELATED ART

The present invention relates to an image forming apparatus of an electrophotographic type.

Conventionally, in the image forming apparatus of the electrophotographic type, a constitution using a liquid developer has been known.

Japanese Laid-Open Patent Application (JP-A) 2015-127812 discloses a constitution of an image forming apparatus using a liquid developer of an ultraviolet curable type, in which the liquid developer transferred on a recording material (medium) is irradiated with ultraviolet radiation (rays), so that an image is fixed on the recording material.

However, a state of the recording material is different depending on an ambient (environmental) temperature of the recording material. Particularly, in the case where the temperature of the recording material used in image formation is low, a temperature of a curable agent contained in the liquid developer lowers by contact with the recording material. For that reason, as in JP-A 2015-127812, only by irradiation with the ultraviolet radiation by an ultraviolet irradiating device, there was a liability that ultraviolet irradiation energy supplied to the liquid developer on the recording material is insufficient and a degree of curing of the liquid developer is insufficient. As a result, there was a liability of a lowering in adhesiveness between the liquid developer and the recording material (improper fixing).

### SUMMARY OF THE INVENTION

A principal object of the present invention is to provide an image forming apparatus, of an electrophotographic type using a liquid developer of an ultraviolet curable type, capable of suppressing generation of improper fixing.

According to an aspect of the present invention, there is provided an image forming apparatus comprising: an accommodating portion configured to accommodate a recording material; a first heating portion configured to heat the recording material accommodated in the accommodating portion; a recording material feeding portion configured to feed the recording material from the accommodating portion; an image forming portion configured to form an image, on a surface of the recording material fed by the recording material feeding portion, with a liquid developer containing toner and an ultraviolet curable agent; a second heating portion configured to heat the image, formed on the surface of the recording material, by irradiating the surface of the recording material with infrared radiation; and an ultraviolet irradiating portion configured to irradiate the surface of the recording material, with ultraviolet radiation, already irradiated with the infrared radiation by the second heating portion.

According to another aspect of the present invention, there is provided an image forming apparatus comprising: an accommodating portion configured to accommodate a recording material; a recording material feeding portion configured to feed the recording material from the accommodating portion; an image forming portion configured to form an image, on a surface of the recording material fed by the recording material feeding portion, with a liquid developer containing toner and an ultraviolet curable agent; a second heating portion configured to heat the image, formed on the surface of the recording material, by irradiating the surface of the recording material with infrared radiation; an ultraviolet irradiating portion configured to irradiate the surface of the recording material, with ultraviolet radiation, already irradiated with the infrared radiation by the second heating portion; and a second heating portion configured to heat the recording material on a feeding path of the recording material from a recording material feeding position where the recording material feeding portion feeds the recording material to an ultraviolet irradiation position where the image is irradiated with the ultraviolet radiation by the ultraviolet irradiating portion.

Further features of the present invention will become apparent from the following description of exemplary embodiments with reference to the attached drawings.

### BRIEF DESCRIPTION OF THE DRAWINGS

FIG. 1 is a schematic view showing a general structure of an image forming apparatus.

FIG. 2 is a block diagram showing a constitution of control of the image forming apparatus.

FIG. 3 is a schematic view showing a cross-section of a developer curable by ultraviolet radiation.

FIG. 4 is a schematic view showing an example of arrangement of an LED of an ultraviolet irradiating device.

FIG. 5 is a graph showing an illuminance distribution of the ultraviolet irradiating device relative to a position with respect to a recording material feeding direction.

In FIG. 6, (a) to (c) are graphs each showing spectral radiant energy density of a heater.

FIG. 7 is a graph showing an absorption wavelength distribution of a liquid developer.

FIG. 8 is a graph showing an illuminance distribution of each of the ultraviolet irradiating device and an infrared irradiating device relative to the position of the recording material with respect to the feeding direction.

FIG. 9 is a graph showing an integrated light quantity necessary for curing relative to a surface temperature of a liquid developer.

FIG. 10 is a graph showing an example of an absorption wavelength distribution of plain paper.

FIG. 11 is a graph showing an example of an absorption wavelength distribution of coated paper.

FIG. 12 is a schematic view showing a general structure of an image forming apparatus.

### DESCRIPTION OF THE EMBODIMENTS

Embodiments of the present invention will be described specifically with reference to the drawings. Constituent elements described in the following embodiments are only examples, and are not intended to limit the present invention to those described in the embodiments.

### Embodiment 1

### (General Structure of Image Forming Apparatus)

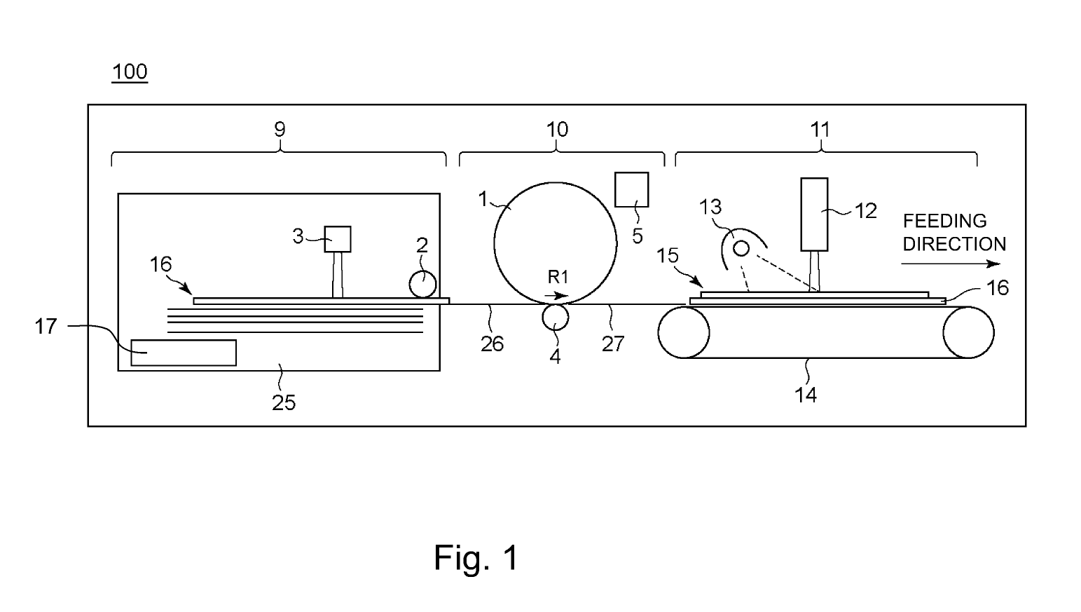

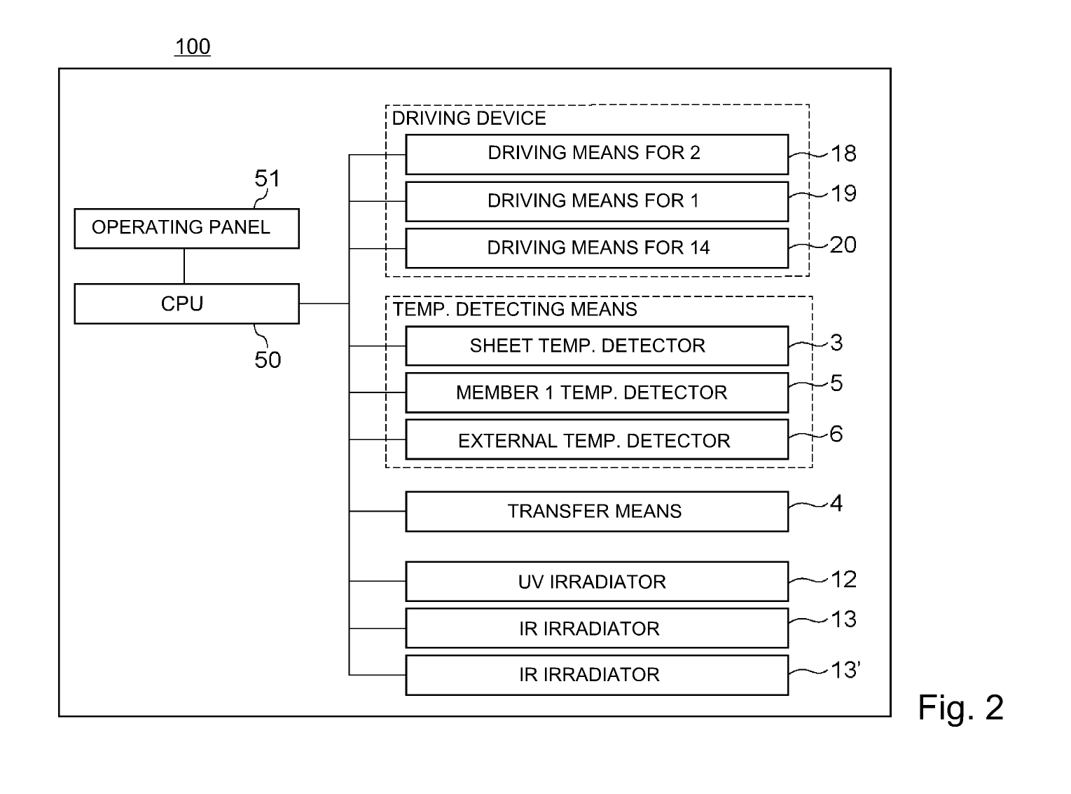

FIG. 1 is a schematic view showing a general structure of an image forming apparatus. FIG. 2 is a block diagram showing a constitution of control of the image forming apparatus.

An image forming apparatus 100 includes an operating panel 51 (FIG. 2). The operating panel 51 includes a display panel as a displaying means (display portion) for displaying information by an instruction from a CPU (central processing unit) 50 as a controlling portion (controller) and includes operating buttons as an inputting means (input portion) for inputting an instruction by an operator. The operating panel 51 displays a state of the image forming apparatus and a menu when various settings are made.

The CPU 50 functions as a controller for effecting integrated control of an operation of the image forming apparatus 100. The CPU 50 executes control of various devices electrically connected with the CPU 50 in accordance with programs and data stored in a storing means (such as an electronic memory) incorporated therein. For example, the CPU 50 is connected with a driving means 18 for a feeding mechanism 2, a driving means 19 for an image holding (bearing) member 1 and a driving means 20 for a feeding belt 14, and control drive and stop of the drive of each of the driving means. Further, the CPU 50 is connected with a temperature detecting means 3 of a recording material (medium), a temperature detecting means 5 of the image holding member 1 and an external temperature detecting means 6, and acquires measured values. Further, the CPU 50 is electrically connected with an ultraviolet irradiating device 12 and an infrared irradiating device 13 which are described later, and controls ON/OFF of these means and outputs of these means.

Incidentally, the storing means is not limited to one incorporated in the CPU 50, but may also have a constitution in which a memory electrically connected with the CPU 50 is provided separately from the CPU 50 and functions as a storing means for storing the programs and data.

As shown in FIG. 1, the image forming apparatus 100 includes a recording material feeding portion 9, an image forming portion and a fixing portion 11.

The recording material feeding portion 9 includes a cassette 25 as an accommodating portion for accommodating a recording material 16 used in image formation and the feeding mechanism 2 for feeding the recording material 16 accommodated in the cassette 25 toward the image forming portion 10. The feeding mechanism 2 is a recording material feeding roller, for example, and feeds the recording material in the cassette 25 to a feeding path 26. The feeding mechanism 2 is driven by the driving means 18 for the feeding mechanism 2. Incidentally, the accommodating portion may also have a tray shape (e.g., a manual feeding tray).

Further, the recording material feeding portion 9 includes the recording material (sheet) temperature detecting means 3 for detecting a temperature of the recording material 16 before image formation. The recording material temperature detecting means 3 measures a surface temperature of the recording material 16 subjected to the image formation. For example, the temperature detecting means 3 is provided in the neighborhood of the feeding mechanism 2 and measures the surface temperature of the recording material 16 fed by the feeding mechanism 2. Further, for example, the temperature detecting means 3 is disposed inside the cassette 25 and measures the surface temperature of an uppermost sheet (subsequently fed by the feeding mechanism 2) of sheets of the recording material 16 accommodated in the cassette 25. In this embodiment, as the recording material temperature detecting means 3, a radiation thermometer (e.g., “IT-450”, manufactured by HORIBA Ltd.) of a non-contact type is used.

Here, the recording material (recording material) 16 is a recording material on which a toner image is formed by the image forming apparatus, and at least includes sheets such as plain paper principally consisting of pulp and a filler and coated paper having a surface layer which is a coating layer of kaolin or calcium carbonate or the like and a resin material. The sheets may also include a postcard and an envelope. The image forming apparatus 100 may also have a constitution in which the image forming apparatus 100 is capable of forming the image on an OHP sheet, a film or the like. In this embodiment, as the recording material 16 on which the image is formed by the image forming apparatus 100, the case where the plain paper or coated paper having a basis weight of 52-300 g/m² (gsm) will be described as an example.

The type of the recording material 16 used in image formation is inputted from the operating panel 51 by the operator. The CPU (acquiring portion) 50 acquires information on the recording material 16 by receiving input of a value of the basis weight of the recording material 16 used through the operating panel 51. Incidentally, the image forming apparatus 100 may also employ a constitution in which the image forming apparatus 100 is connectable with an external device (e.g., a personal computer or an information terminal via a network and in which selection of the kind (plain paper or coated paper) of the recording material 16 used, and the input of the value of the basis weight of the recording material 16 used are received from the external device.

In this embodiment, a constitution in which as the recording material 16, a cut sheet (e.g., A4-sized sheet (210 mm×297 mm) or the like) is used is employed, but a constitution in which rolled paper is used as the recording material 16 may also be employed.

The recording material 16 fed from the cassette 25 by the feeding mechanism 2 passes through a feeding path 26 and is supplied to a contact portion between the image holding member 1 and a transfer means 4. After the image on the image holding member 1 is transferred onto the recording material 16, the recording material 16 passes through a feeding path 27 and is fed to the fixing portion 11.

The image forming portion 10 forms the image with a liquid developer (liquid) 15 on the recording material (recording material) 16. The liquid developer 15 is a developer containing an ultraviolet curable agent curable by ultraviolet radiation (rays) and a coloring material (colorant), and will be described specifically later. The image forming portion 10 includes a roller-shaped image holding member 1 and a roller-shaped transfer means 5. An image forming means (not shown) of an electrophotographic type includes a charging portion where the image holding member 1 is electrically charged to a uniform surface potential, an exposure portion where a latent image is formed by light exposure, and a developing portion where the latent image is developed using the liquid developer 15, and forms the image on the image holding member 1. The image formed on the image holding member 1 is transferred by a transfer roller as the transfer means 4 onto the recording material 16 supplied to a contact portion (image forming position) between the image holding member 1 and the transfer means 4. That is, by the image forming portion 10, on the recording material 16, an unfixed image is formed.

The image holding member 1 in this embodiment is an aluminum-made cylinder (photosensitive drum) which has an organic photosensitive layer of 3 mm in thickness and which has an outer diameter of 84 mm, and is 370 mm in long-side width (i.e., a length with respect to a direction substantially perpendicular to a recording material feeding direction). The image holding member 1 is rotationally driven about a center supporting shaft (axis) at a process speed (peripheral speed) of 800 mm/sec in an arrow R1 direction in FIG. 1 by a driving motor (DC brush-less motor) as the driving means 19 for the image holding member 1. The image holding member 1 includes a heater (not shown) as a heating means at an inside thereof, and is provided with the temperature detecting means 5 for the image holding member 1 in the neighborhood thereof. As the temperature detecting means 5 for the image holding member 1, a thermistor or a thermocouple may suitably be used.

In this embodiment, the constitution of the image holding member 1 uses a direct transfer type of the electrophotographic type, but an image forming method on the recording material 16 is not limited thereto. For example, a constitution using an intermediary transfer type in which the image holding member 1 is an intermediary transfer belt may also be employed. Specifically, the image formed on the photosensitive drum with the liquid developer 15 by the image forming means (not shown) is primary-transferred onto the intermediary transfer member by a primary transfer roller. The transfer means 4 is used as a secondary transfer roller and transfers the image from the intermediary transfer member onto the recording material 16.

The recording material 16 on which the image is formed at the image forming portion 10 is irradiated with the ultraviolet radiation by the ultraviolet irradiating device 12.

The surface of the image holding member 1 in this embodiment is temperature-controlled at 40±5° C., and also a temperature of the liquid developer is approximately 40±5° C. on the image holding member 1. In the case a temperature of the recording material 16 fed to the image holding member 1 is lower than the temperature of the image holding member 1, the temperature of the liquid developer 15 is lowered by the transfer of the image onto the recording material 16.

The image forming apparatus 100 includes the infrared irradiating device (infrared input irradiating portion) 13 as a heating portion for heating the recording material 16 which is an object to be irradiated with the ultraviolet radiation by the ultraviolet irradiating device (ultraviolet irradiating portion) 12. The heating portion is provided, for heating the recording material 16 before the recording material 16 is irradiated with the first radiation by the ultraviolet irradiating device 12, on a feeding path (e.g., the feeding path 26, the feeding path 27, the feeding belt 14) between a recording material feeding position of the recording material feeding portion 9 to an ultraviolet irradiation position where the recording material 16 is irradiated with the ultraviolet radiation by the ultraviolet irradiating device 12. In this embodiment, the recording material feeding position refers to a boundary position between the cassette 25 and the feeding path 26. Further, in this embodiment, the ultraviolet irradiation position refers to a position where in a positional distribution with respect to the feeding direction of the recording material 16, illuminance by the ultraviolet irradiating device 12 is maximum (peak illuminance).

In this embodiment, in order to heat the recording material 16 after the image formation (i.e., after the transfer) and before the irradiation with the ultraviolet radiation, the infrared irradiating device 13 is provided downstream of the image holding member 1 and upstream of the ultraviolet irradiating device 12 with respect to the feeding direction of the recording material 16 (FIG. 1). By the infrared irradiating device 13, a surface of the recording material 16, after the image formation and before the irradiation with the ultraviolet radiation, on which the image which has not been irradiated with the ultraviolet radiation is formed is irradiated with the ultraviolet radiation.

Incidentally, also a constitution in which the cassette 25 in which the recording material 16 before the image formation is accommodated is provided with a warming means (heating portion) 17 may preferably be employed. The warming means 17 heats the recording material 16 accommodated in the cassette 25. As the warming means for the cassette 25, a heat generation element or the like consisting of a resistor is effectively used.

The recording material 16 on which the image on the image holding member 1 is transferred by the transfer means 4 is fed to the fixing portion 11. The fixing portion 11 includes the ultraviolet irradiating device 12 and the feeding belt 14, and fixes the image of the liquid developer 15 on the recording material 16 by irradiating the recording material 16 with the ultraviolet radiation by the ultraviolet irradiating device 12. The feeding belt 14 feeds the recording material 16, on which the unfixed image is carried, to a position below the ultraviolet irradiating device 12.

### (Ultraviolet Irradiating Device)

The ultraviolet irradiating device 12 uses, as a light source, an LED (light emitting diode) 31 for radiating the ultraviolet radiation. Of importance to ultraviolet curing reaction is first law of photochemistry (Grotthuss-Drapper's law), i.e., that a photochemical change is caused only by a fraction of incident light which is absorbed by a substance. That is, in the ultraviolet curing reaction, it is important that an absorption wavelength of a photopolymerization initiator contained in the developer and an emission wavelength of the ultraviolet irradiating device 12 coincide with each other. As regards the wavelength of the LED, there are LED light sources with peaks (spectral distribution peak of radiant energy density) at 365±5 nm, 385±5 nm, 405±5 nm and the like, and therefore, the absorption wavelength of the photopolymerization initiator may preferably fall within these wavelength ranges (regions).

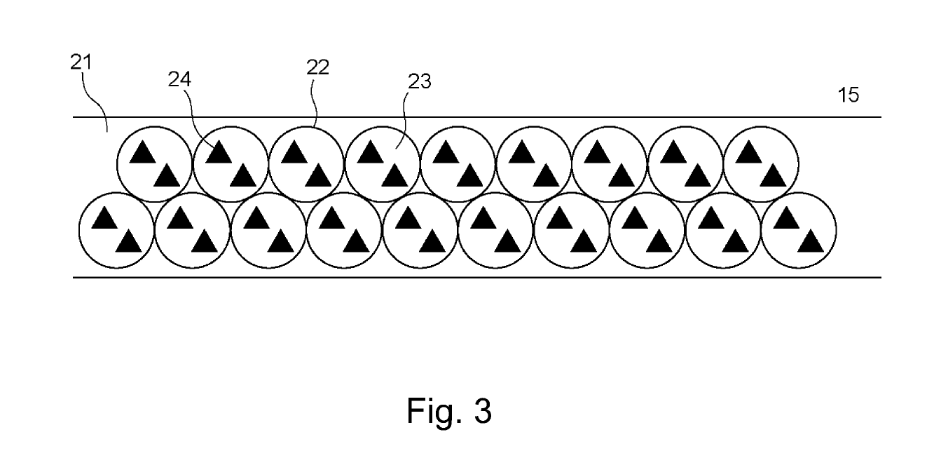

FIG. 3 is a schematic view showing a cross-section of the liquid developer 15 to be caused by the ultraviolet radiation (rays). The liquid developer 15 contains an ultraviolet curable agent 21 and toner 22. The ultraviolet curable agent 21 at least contains the photopolymerization initiator and a monomer for the ultraviolet curable agent. The toner 22 contains a resin material 23 as a base material and a coloring material 24. For example, in the case of a cationic polymerization, when the ultraviolet curable agent is irradiated with the ultraviolet radiation, the photopolymerization initiator excited by the ultraviolet radiation generates an acid, and the generated acid and the monomer start polymerization reaction, so that the ultraviolet curable agent 21 is cured.

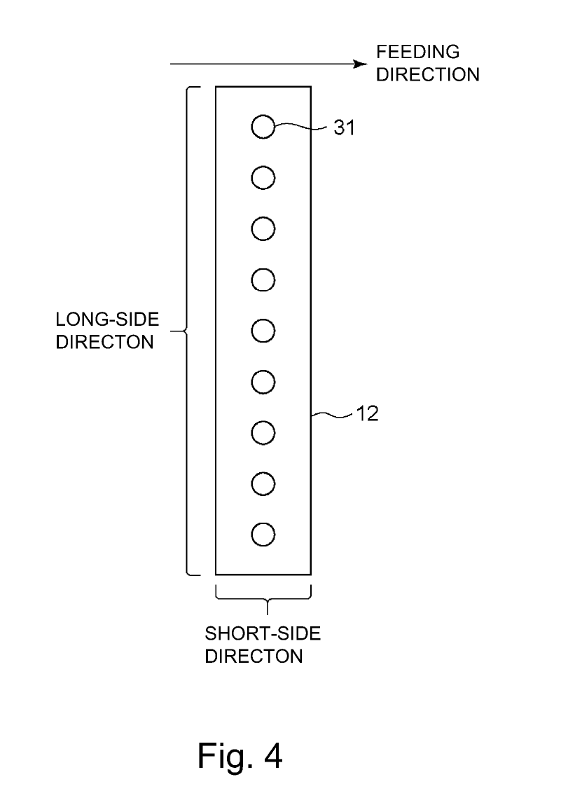

FIG. 4 is a schematic view showing an example of arrangement of the LED of the ultraviolet irradiating device 12. LEDs 31 radiating the ultraviolet radiation are disposed so as to oppose a region of the feeding belt 14 contacting the recording material 16 fed, and radiates the ultraviolet radiation to the recording material 16 on the feeding belt 14. Here, the ultraviolet irradiating device 12 includes the plurality of LEDs 31 so as to irradiate an entire region of the image with the ultraviolet radiation with respect to a widthwise direction (perpendicular to the feeding direction) of the recording material 16. The LEDs 31 radiating the ultraviolet radiation may have a constitution in which the LEDs 31 are arranged in a line along a long-side direction perpendicular to the feeding direction as shown in FIG. 4 and may also have a constitution in which a plurality of arrays each having the LEDs 31 as shown in FIG. 4 are arranged in a plurality of lines along the feeding direction.

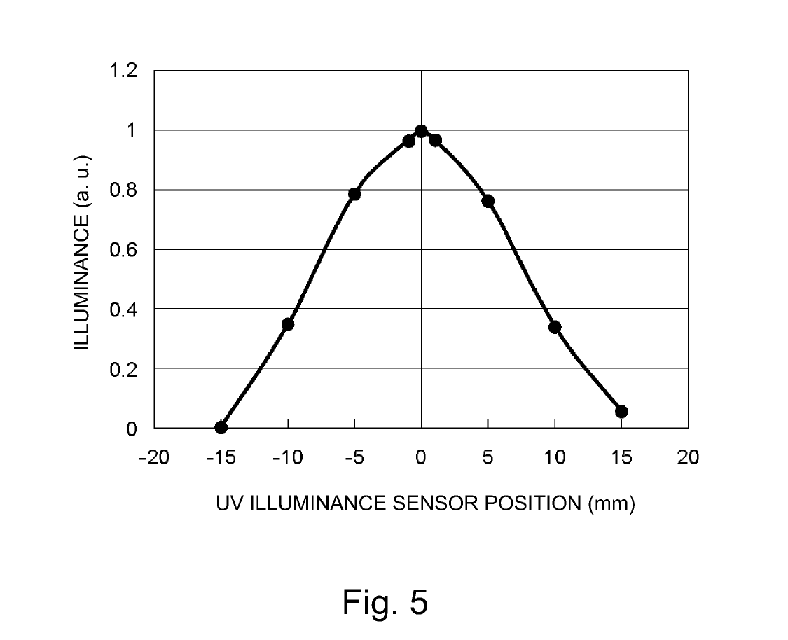

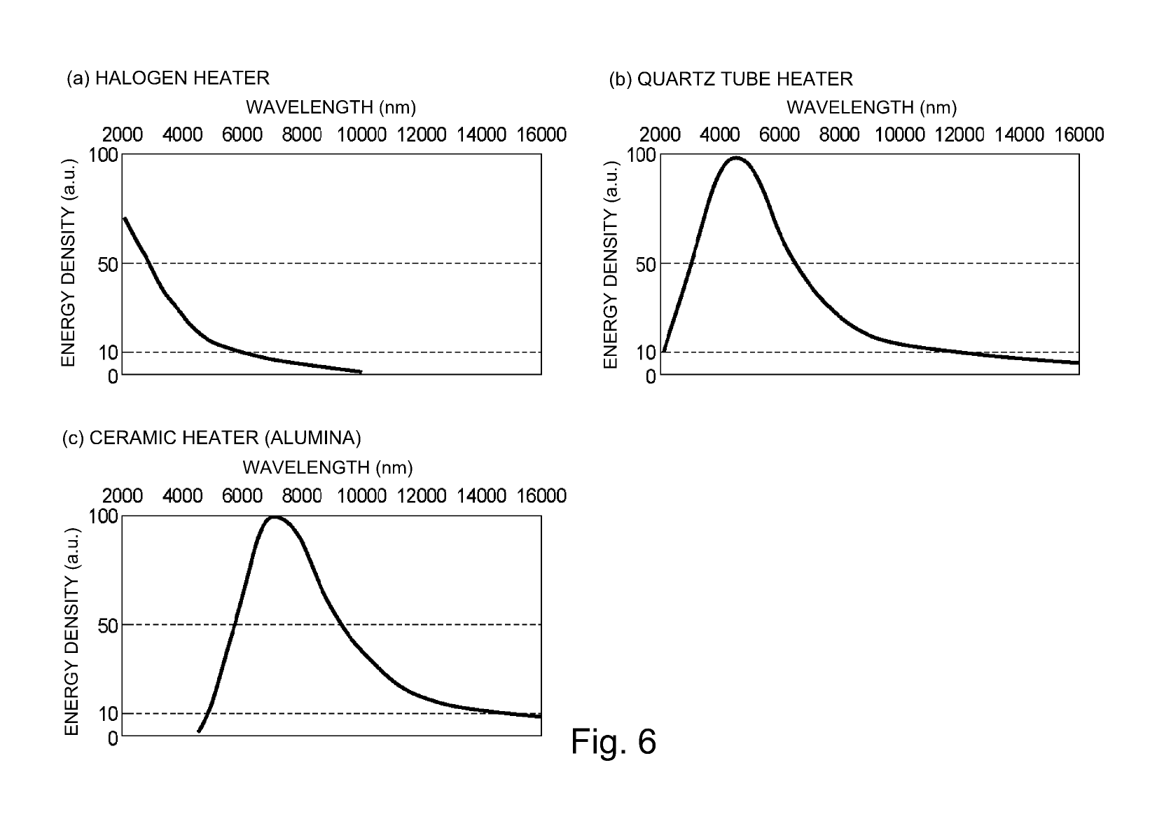

FIG. 5 is a graph showing an illuminance distribution of the ultraviolet irradiating device relative to a position of an illuminance sensor with respect to the recording material feeding direction. Specifically, FIG. 5 shows the illuminance distribution of the ultraviolet irradiating device 12 in which the peak (spectral distribution peak of the radiant energy density) is in the wavelength range of 385±5 nm and a value thereof is 1.8 W/cm². In FIG. 5, the position of the illuminance sensor immediately below the LEDs 31 is 0 (mm), and the LEDs 31 are provided at different positions with respect to the feeding direction of the recording material 16 and the illuminance by the ultraviolet irradiating device 12 is measured. That is, FIG. 5 shows the illuminance distribution of the ultraviolet irradiating device 12 relative to the position of the illuminance sensor with respect to the feeding direction of the recording material 16. In a positional distribution on a surface of an object to be irradiated with respect to the feeding direction, the illuminance which is a maximum illuminance is referred to as peak illuminance. In FIG. 5, the illuminance at the position (where the ultraviolet illuminance sensor position is 0 (mm)) immediately below the LEDs 31 is the peak illuminance.

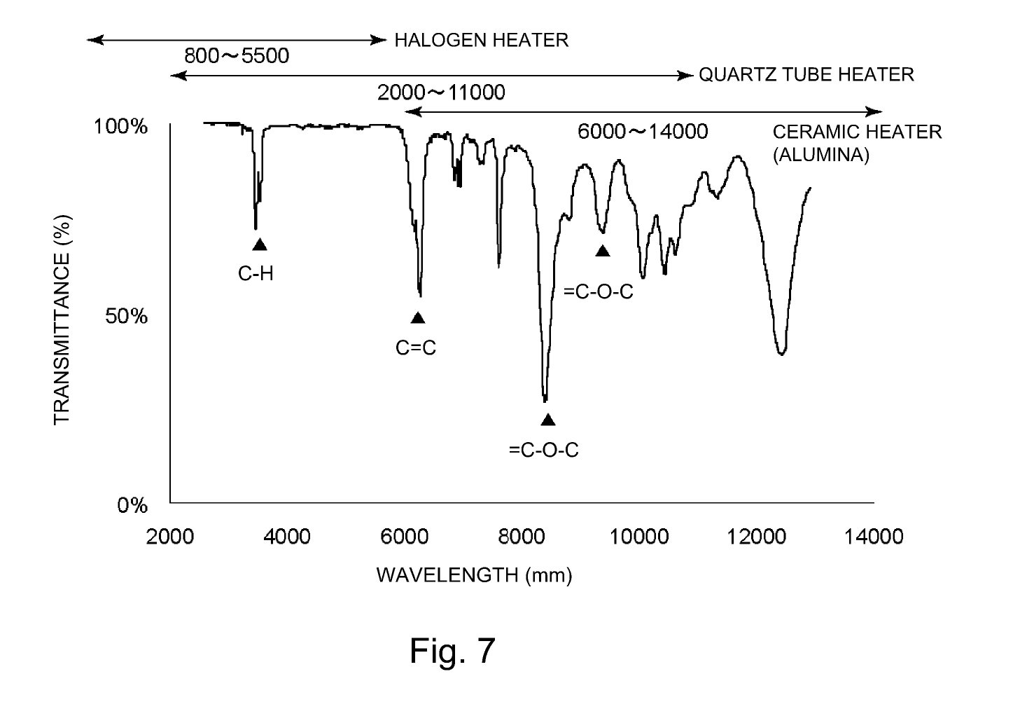

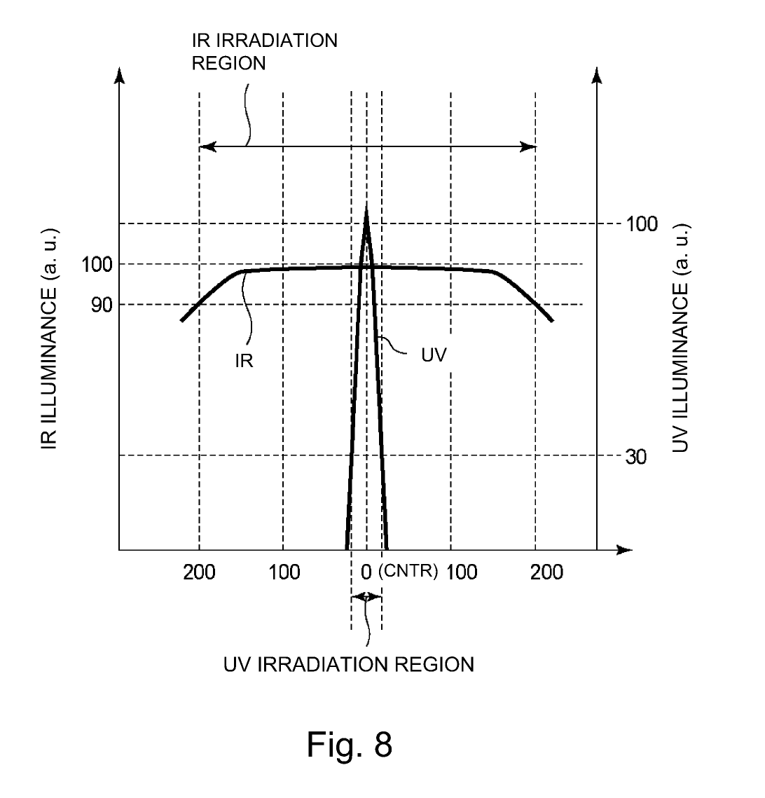

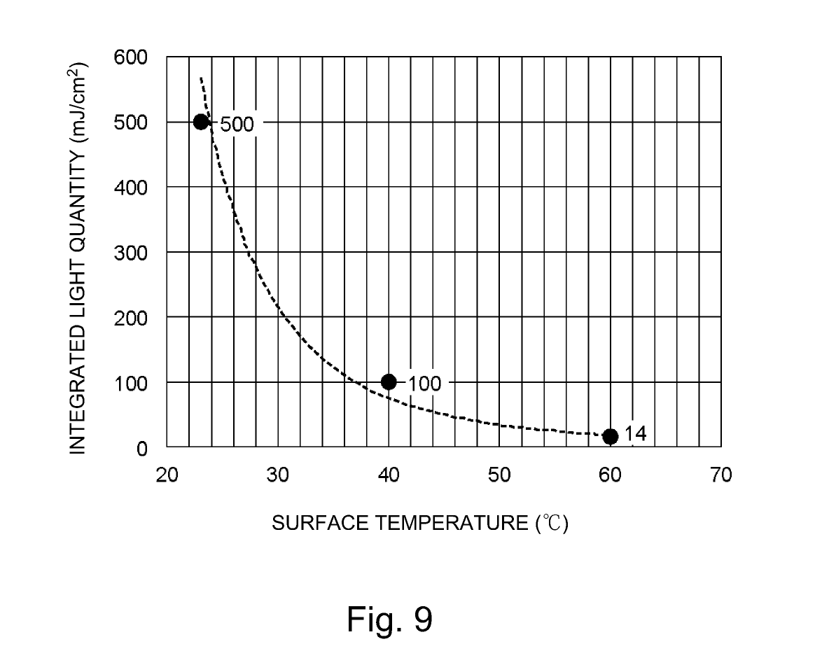

In FIG. 5, the unit “(a.u.)” represents an arbitrary unit. This is true for also FIGS. 7 and 8. Further, the irradiation energy (radiant energy) per unit area is a total amount (integrated light quantity: mJ/cm²) of photons which reach the surface of the object to be irradiated. That is, the illuminance shown in FIGS. 5 and 9 is the product of integrated illuminance (mW/cm²) and irradiation time (sec), i.e., (mW/cm²)×(sec), of the ultraviolet irradiation position 12 at each wavelength. (Infrared irradiating device)

The infrared irradiating device 13 radiates electromagnetic wave (infrared input radiation) from a light source with a far-infrared input region wavelength (1000 nm-15000 nm).

As a member for radiating the infrared input radiation, for example, a halogen heater, a quartz tube heater and a ceramic heater exist. In FIG. 6, (a) to (c) are graphs each showing spectral radiant energy density of the associated heater, in which (a) shows the spectral radiant energy density of the halogen heater, (b) shows the spectral radiant energy density of the quartz tube heater, and (c) shows the spectral radiant energy density of the ceramic heater. In these figures, the ordinate represents the spectral radiant energy density when a maximum of the spectral distribution peak of the radiant energy density at the far-infrared input region wavelength (1000 nm-15000 nm) is 100.

The halogen heater is a heater such that a tungsten filament is heated by being energized and the infrared input radiation (about 800 nm-about 5500 nm) is radiated. The quartz tube heater is a heater such that a nichrome wire filament is heated by being energized and the infrared input radiation (about 2000 nm-about 11000 nm) is radiated. The ceramic heater is capable of radiating a long-wavelength infrared input radiation (about 6000 nm-about 14000 nm) in the case of alumina. Here, values in parentheses show wavelength regions (ranges) in which when the maximum of the spectral radiant energy density in the far-infrared input region in the associated heater is 100%, the spectral radiant energy density is not less than 10% of the maximum.

The infrared irradiating device 13 causes the infrared input radiation radiated from the filament to be reflected by a metal having a high reflectance in the infrared input region (range), so that the recording material 16 is irradiated with the reflected infrared input radiation. For example, a reflection plate formed of high-purity aluminum has a high reflectance in the infrared input region and is capable of reflecting the infrared input radiation with efficiency.

The infrared irradiating device 13 increases the temperature of the liquid developer 15 on the recording material 16 by irradiating, with the infrared radiation, the surface of the recording material 16 on which the image which has not been irradiated with the ultraviolet radiation is formed. Further, the ultraviolet irradiating device 13 promotes molecular vibration of the recording material 16 by irradiating the recording material 16 with the infrared radiation, and thus increases the temperature of the recording material 16.

FIG. 7 is a graph showing an absorption wavelength distribution of the liquid developer, and shows the absorption wavelength distribution of the ultraviolet curable agent contained in the liquid developer. For example, C═C bond absorbs the infrared input radiation of 6200 nm in wavelength, and C—O—C bond absorbs the infrared input radiation of 8350 nm and 9350 nm in wavelength.

FIG. 7 shows principal wavelengths of the representative heaters in addition to the absorption wavelength distribution of the liquid developer 15 in this embodiment. Here, the absorption wavelength of the liquid developer 15 is contained in the wavelength of the electromagnetic wave in the far-infrared input region where the infrared irradiating device 13 radiates the electromagnetic wave. Accordingly, the infrared irradiating device 13 as the heating portion for heating the recording material 16 can heat also the liquid developer 15 on the recording material 16.

Specifically, it is desirable that the absorption wavelength of the liquid developer 15 is contained in a wavelength region where the spectral radiant energy density is not less than 10% of the maximum of the spectral radiant energy density in the far-infrared input region where the infrared irradiating device 13 radiates the electromagnetic wave.

As shown in FIG. 7, in a wavelength region of 6000 nm-11000 nm (i.e., 6000 nm or more and 11000 nm or less), an absorption wavelength resulting from the C═C bond of the liquid developer 15 and an absorption wavelength resulting from the C—O—C bond of the liquid developer 15 are contained. Here, the wavelength region of 6000 nm-11000 nm is a wavelength (region) at which the recording material 16 can be efficiently heated. Accordingly, as in the liquid developer 15 in this embodiment, by using the vinyl ether compound as the ultraviolet curable agent, also the liquid developer 15 on the recording material 16 can be efficiently heated. As a result, the temperature of the liquid developer 15 increases. A curing reaction is accelerated, so that it is possible to suppress a light quantity of the ultraviolet irradiating device 12 necessary to cure the liquid developer 15 and it is possible to suppress an increase in consumed energy of the ultraviolet irradiating device 12.

As the light source of the infrared irradiating device 13, it is desirable that the light source which radiates the electromagnetic wave having the spectral radiant energy density, in the wavelength region of 6000 nm-11000 nm (i.e., not less than 6000 nm and not more than 11000 nm), which is not less than 10% of the maximum of the spectral radiant energy density is used. For example, as the light source of the infrared irradiating device 13, by using a quartz tube heater, a ceramic heater (alumina) or the like.

(Ultraviolet Irradiating Device and Infrared Irradiating Device)

Next, a relationship between an infrared input irradiation region and an ultraviolet irradiating region is shown in FIG. 8. FIG. 8 is a graph showing illuminance distributions of the ultraviolet irradiating device and the infrared irradiating device relative to the position with respect to the recording material feeding direction. In FIG. 8, the abscissa represents the position with respect to the recording material feeding direction, in which the position where the illuminance of the ultraviolet irradiating device 12 is maximum (peak illuminance) is taken as a reference (center) P. The infrared input irradiation region is a region where the illuminance is not less than 90% of the peak illuminance of the infrared irradiating device 13. The ultraviolet irradiation region is a region where the illuminance is not less than 30% of the peak illuminance of the ultraviolet irradiating device 12. The infrared irradiating device 13 has the infrared input irradiation region in a side upstream of the ultraviolet irradiation region with respect to the feeding direction of the recording material 16, and heats the recording material 16 to be fed to the ultraviolet irradiating device 12.

Incidentally, compared with the ultraviolet irradiation region, the infrared input irradiation region is broad but can be changed by changing a shape of the reflection mirror.

Further, the center of the infrared input irradiation region may also be positioned upstream of the center of the ultraviolet irradiation region with respect to the feeding direction of the recording material 16. In the following, a result of study on the case where the center of the infrared input irradiation is positioned upstream of the center of the ultraviolet irradiation region will be described.

FIG. 9 is a graph showing an integrated light quantity (mJ/cm²) necessary to cure the liquid developer 15 with respect to the surface temperature of the liquid developer 15 during the ultraviolet irradiation. The ultraviolet irradiating device 12 radiates the ultraviolet radiation with a maximum of the spectral illuminance falling in a range of 385±5 nm. Thus, when the surface temperature of the liquid developer 15 during the ultraviolet irradiation increase, the integrated light quantity (mJ/cm²) necessary to cure the liquid developer 15 becomes small.

In the following, as the ultraviolet irradiating device 12, one providing the integrated light quantity of 100 mJ/cm² is used. In this case, in order to cure the liquid developer 15 by the ultraviolet irradiating device 12, the surface temperature of the liquid developer 15 during the ultraviolet irradiation may desirably be about 40° C±5° C. (FIG. 9).

(Liquid Developer Used in this Embodiment)

The ultraviolet curable agent of the liquid developer 15 used in this embodiment is a cationic polymerizable monomer. The cationic polymerizable monomer is a vinyl ether compound, and it is possible to use dichloropendadiene vinyl ether, cyclohexanedimethanol divinyl ether, tricyclodecane vinyl ether, trimethylolpropane trivinyl ether, 2-ethyl-1,3-hexanediol divinyl ether, 2,4-diethyl-1,5-pentanediol divinyl ether, 2-butyl-2-ethyl-1,3-propanediol divinyl ether, neopentylglycol divinyl ether, pentaerythritol tetravinyl ether, and 1,2-decanediol divinyl ether.

The ultraviolet curable agent (monomer) of the liquid developer 15 in this embodiment is a mixture of about 10% (wt. %) of a monofunctional monomer (formula 1 below) having one vinyl ether group and about 90% (wt. %) of a difunctional monomer (formula 2 below) having two vinyl ether groups.

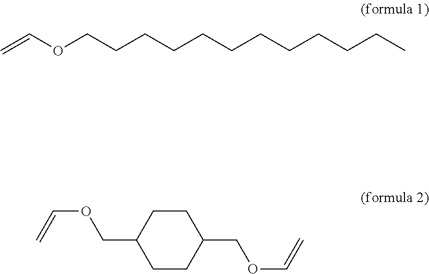

As the photopolymerization initiator, a compound (formula 3) shown below is mixed in an amount of 0.1%. By using this photopolymerization initiator, different from the case where an ionic photo-acid-generating agent, it is possible to obtain a high-resistance liquid developer 15 while achieving a good fixing property.

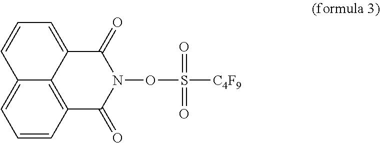

### (Temperature of Recording Material)

As described above, the surface temperature of the liquid developer 15 during the ultraviolet irradiation may desirably be about 40° C.±5° C., but the temperature o the liquid developer 15 is influenced by the temperature of the recording material 16.

After the image formed on an entire surface of the recording material 16 with the liquid developer 15 is fixed at the fixing portion 11, the surface of the recording material 16 was touched with a finger to check tack (tackiness), and the tack was evaluated in 3 ranks.

Rank 3: No tack is recognized.

Rank 2: Tack is slightly recognized.

Rank 1: A film is peeled off during touch with the finger or has not been cured.

According to study by the present inventor, it was confirmed that a desirable curing state (rank 3) was able to be obtained when the temperature of the recording material 16 at the ultraviolet irradiation position is not less than 40° C. In this embodiment, the ultraviolet irradiation position refers to a position where the illuminance by the ultraviolet irradiating device 12 is maximum (peak illuminance) in a positional distribution with respect to the feeding direction of the recording material 16.

The temperature of the recording material 16 varies depending on an ambient (environmental) temperature. For example, in the case where the recording material 16 stored in a low temperature environment (e.g., 5° C.) until just before is accommodated in the cassette 25, the recording material 16 of which temperature is still low (e.g., about 5° C.) is used in the image formation. In such a case, there is a liability that the temperature of the liquid developer 15 is lowered by a cold recording material 16 and a degree of the curing of the liquid developer 15 by the ultraviolet radiation becomes insufficient.

Therefore, the image forming apparatus 100 is provided with the heating means 17 in the cassette 25, and the recording material 16 accommodated in the cassette 25 is heated. As a result, the heating means 17 heats the recording material 16 accommodated in the cassette 25, so that the temperature of the recording material at the ultraviolet irradiation position increases and thus improper fixing can be suppressed.

### Embodiment 2

In Embodiment 1, a constitution in which the infrared irradiating device 13 is provided downstream of the image holding member 1 with respect to the feeding direction of the recording material 16 and in which the heating means 17 is provided in the cassette 25 was employed. In Embodiment 2, an infrared irradiating device 13′ as a heating portion for heating the recording material 16 before the ultraviolet irradiation is provided downstream of the recording material feeding portion 9 and upstream of the image holding member 1 with respect to the feeding direction of the recording material 16 may also be employed.

The vibration absorption wavelength of the chemical bond contained in the recording material 16 is in the far-infrared region, and therefore the recording material 16 can be heated with efficiency by being irradiated with far-infrared radiation corresponding to the absorption wavelength of the recording material 16.

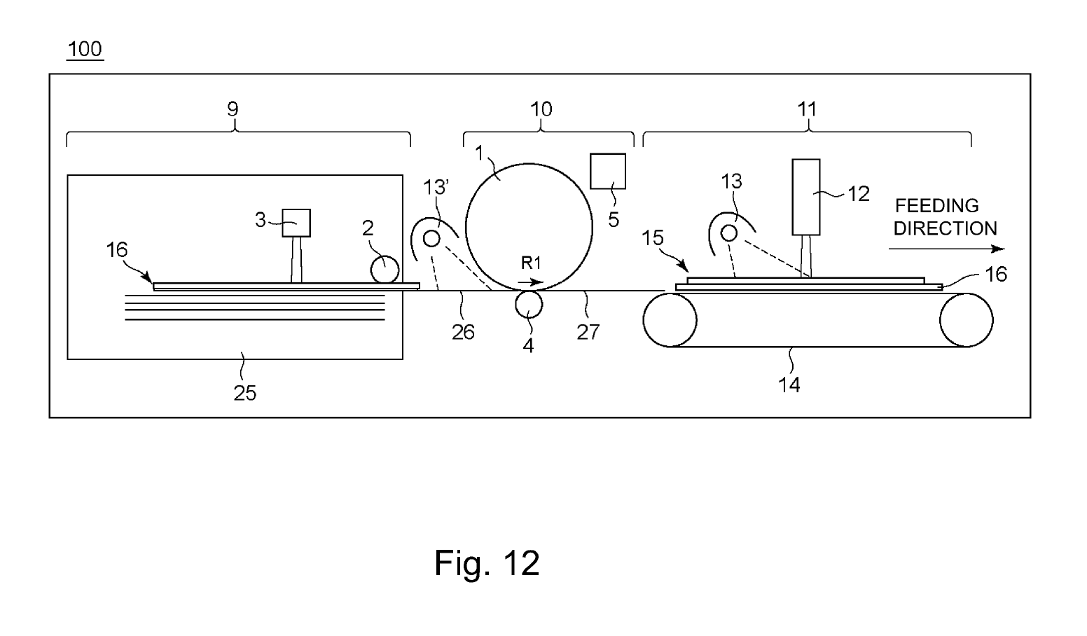

Specifically, as shown in FIG. 12, the image forming apparatus 100 includes an infrared irradiating device (infrared input irradiating portion) 13′ as the heating portion for heating the recording material 16 to be irradiated with the ultraviolet radiation by the ultraviolet irradiating device 12. The infrared irradiating device 13′ heats the recording material 16 on the feeding path 26. That is, the infrared irradiating device 13′ heats the recording material 16 by irradiating the recording material 16 with the infrared input radiation in a period until the recording material 16 fed by the feeding mechanism 2 of the recording material feeding portion 9 is transferred by the transfer means 4. Incidentally, a detailed constitution of the infrared irradiating device 13′ is similar to that of the above-described infrared irradiating device 13 except for arrangement thereof in the image forming apparatus 100, and therefore will be omitted from description. The CPU 50 is electrically connected with the infrared irradiating device 13′ as shown in FIG. 12 and controls ON/OFF of the infrared irradiating device 13′.

That is, in this embodiment, as shown in FIG. 12, a constitution in which infrared irradiating devices 13′ and 13 as heating portions for heating the recording material 16 to be irradiated with the ultraviolet radiation are provided in front of the image forming portion and behind the image forming portion, respectively, is employed.

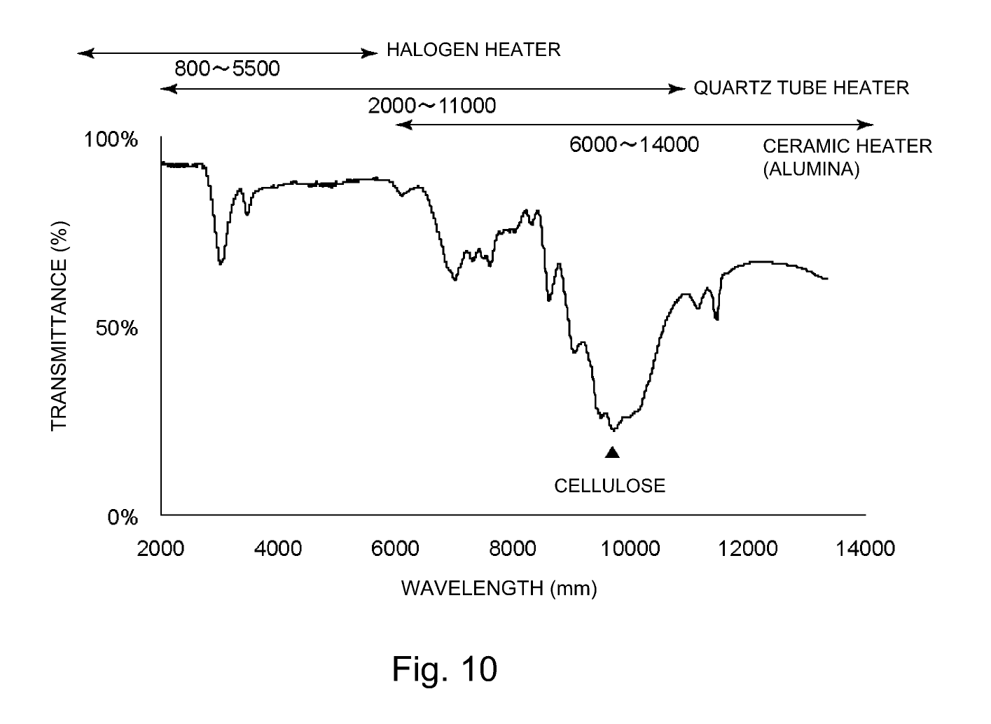

FIG. 10 is a graph showing an example of an absorption wavelength distribution of the plain paper. The plain paper has an absorption wavelength resulting from cellulose in the neighborhood of about 9700 nm, and therefore, when the plain paper is irradiated with the infrared input radiation, the plain paper absorbs a corresponding infrared input wavelength.

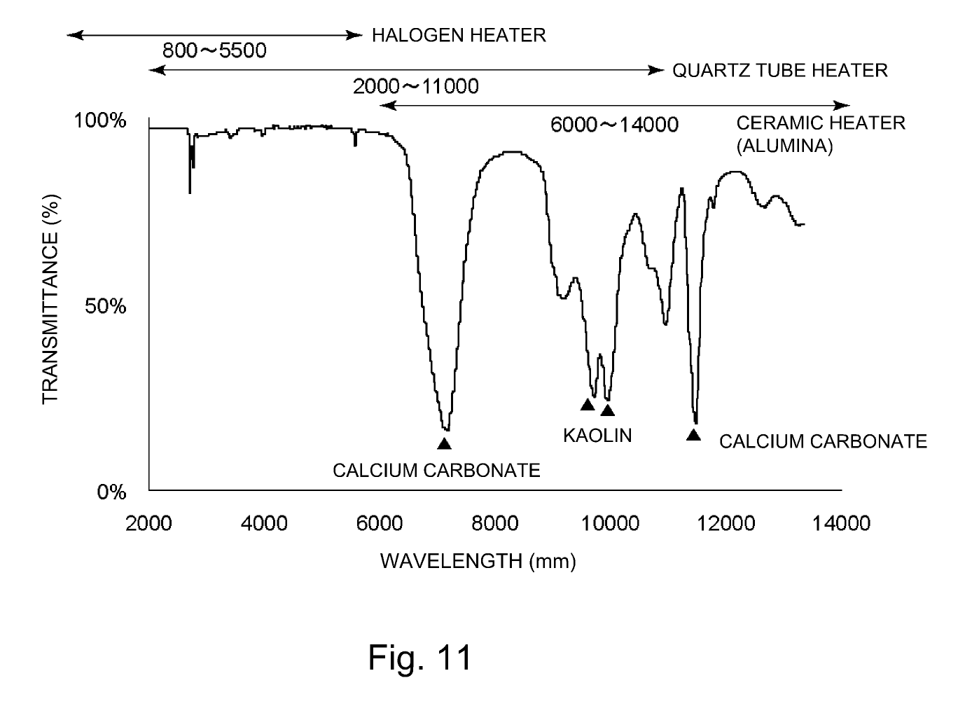

FIG. 11 is a graph showing an example of an absorption wavelength distribution of the coated paper. Most of the coated paper contains calcium carbonate and/or kaolin. The coated paper shown in FIG. 11 contains both of calcium carbonate and kaolin, and FIG. 11 shows the absorption wavelength distribution of the coated paper. An absorption wavelength resulting from calcium carbonate exists at about 7100 nm, and absorption wavelengths resulting from kaolin and cellulose exist in the neighborhood of about 9700 nm, and the coated paper absorbs corresponding infrared input wavelengths.

In FIGS. 10 and 11, in addition to the absorption wavelength distributions of the recording materials, principal wavelengths of the above-described heaters are shown.

The wavelength of the infrared input radiation radiated from the light source of the infrared irradiating device 13 may preferably contain the absorption wavelength of the recording material 16. Specifically, when the absorption wavelength of the recording material 16 is λ, it is desirable that the wavelength region where the recording material 16 is irradiated with the infrared input radiation with the radiant energy density of not less than 10% of the maximum of the spectral radiant energy density in the far-infrared input region of the electromagnetic wave radiated by the infrared irradiating device 13 contains the absorption wavelength λ. The recording material 16 is capable of efficiently absorbing the radiant energy of the wavelength corresponding to the associated vibration absorption wavelength, so that the recording material 16 can be efficiently heated.

As shown in FIGS. 10 and 11, in the wavelength region of 6000 nm-11000 nm (i.e., not less than 6000 nm and not more than 11000 nm), the absorption wavelength resulting from cellulose and the absorption wavelengths resulting from calcium carbonate and kaolin are contained. Accordingly, it is desirable that the light source which radiates the electromagnetic wave having the spectral radiant energy density, in the wavelength region of 6000 nm-11000 nm (i.e., not less than 6000 nm and not more than 11000 nm), which is not less than 10% of the maximum of the spectral radiant energy density is used. For example, as the light source of the infrared irradiating device 13, by using the quartz tube heater, the ceramic heater (alumina) or the like, it is possible to more efficiently heat the recording material 16.

Other constitutions are similar to those in Embodiment 1, and therefore will be omitted from description.

### [Other Constitutions]

In Embodiment 2 described above, the constitution in which the infrared irradiating device 13′ is used as the heating portion for heating the recording material 16 before the ultraviolet irradiation was employed, but the heating portion may also employ a constitution in which the recording material 16 is heated from a back side (surface) of the recording material 16. Incidentally, the back side (surface) refers to a surface, of surfaces of the recording material 16, contacting the feeding paths 26 and 27 and the feeding belt 14. For example, a constitution in which a plate-like heater is provided in the feeding path 26 may also be employed, and a constitution in which a roller in which a heater is incorporated is provided inside the feeding belt 14 may also be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2015-252520 filed on Dec. 24, 2015, and 2016-189954 filed on Sep. 28, 2016, which are hereby incorporated by reference herein in their entirety.

What is claimed is:

1. An image forming apparatus comprising:
an accommodating portion configured to accommodate a recording material;
a first heating portion configured to heat the recording material accommodated in said accommodating portion;
a recording material feeding portion configured to feed the recording material from said accommodating portion;
an image forming portion configured to form an image, on a surface of the recording material fed by said recording material feeding portion, with a liquid developer containing toner and an ultraviolet curable agent;
a second heating portion configured to heat the image, formed on the surface of the recording material, by irradiating the surface of the recording material with infrared radiation; and
an ultraviolet irradiating portion configured to irradiate the surface of the recording material, with ultraviolet radiation, already irradiated with the infrared radiation by said second heating portion.

2. An image forming apparatus comprising:
an accommodating portion configured to accommodate a recording material;
a recording material feeding portion configured to feed the recording material from said accommodating portion;
an image forming portion configured to form an image, on a surface of the recording material fed by said recording material feeding portion, with a liquid developer containing toner and an ultraviolet curable agent;
a second heating portion configured to heat the image, formed on the surface of the recording material, by irradiating the surface of the recording material with infrared radiation;
an ultraviolet irradiating portion configured to irradiate the surface of the recording material, with ultraviolet radiation, already irradiated with the infrared radiation by said second heating portion; and
a second heating portion configured to heat the recording already on a feeding path of the recording material from a recording material feeding position where said recording material feeding portion feeds the recording material to an ultraviolet irradiation position where the image is irradiated with the ultraviolet radiation by said ultraviolet irradiating portion.
